(19) United States
(12) Patent Application Publication
(10) Pub. No.: US 2026/0175591 A1
(43) Pub. Date: Jun. 25, 2026

(54) METHOD AND APPARATUS FOR IMPLEMENTING THERMAL PRINTING

(71) Applicant: Feitian Technologies Co., Ltd., Beijing (CN)

(72) Inventors: Buming TIAN, Beijing (CN); Zhou LU, Beijing (CN)

(73) Assignee: Feitian Technologies Co., Ltd., Beijing (CN)

(21) Appl. No.: 19/124,552

(22) PCT Filed: Oct. 31, 2023
(86) PCT No.: PCT/CN2023/128922

§ 371 Date: Apr. 25, 2025

(30) Foreign Application Priority Data
Dec. 13, 2022 (CN) 202211593660.6

(51) Int. Cl. B41J 2/355; G06K 15/10

(52) U.S. Cl. CPC B41J 2/355; G06K 15/102

(57) ABSTRACT

Methods for implementing thermal printing, including: calculating the number of printable dots based on power information of an electronic device and power consumption of single-dot printing; parsing the received printing instruction to obtain data to be printed and convert it into a two-dimensional dot-matrix pattern, taking information of each row in the pattern sequentially as current information to be printed; if the number of ink dots in the current information to be printed is greater than the number of printable dots, segmenting the current information to be printed based on the number of printable dots; keeping ink-dot positions in information of each segment unchanged, and filling other positions with zeroes to obtain virtual line information; energizing heating elements at corresponding positions on the print head for a preset duration based on the ink-dot positions in each piece of virtual line information sequentially, and controlling a motor to feed paper.

### CROSS-REFERENCE TO RELATED APPLICATIONS

The present application is a national stage of International application No. PCT/CN2023/128922, filed on Oct. 31, 2023, which claims the priority of the Chinese patent application No. 202211593660.6, entitled “METHOD AND APPARATUS FOR IMPLEMENTING THERMAL PRINTING” filed with the China National Intellectual Property Administration on Dec. 13, 2022 Both of the aforementioned applications are hereby incorporated by reference in their entireties.

### TECHNICAL FIELD

The present disclosure relates to the field of data printing and, in particular, to a method and an apparatus for implementing thermal printing.

### BACKGROUND

A thermal printer is currently a commonly used electronic device for receipt and bill printing applications. The thermal printer is consumable-free and fast, but thermal printing has a high requirement for power. In order to reduce a high current demand of a print head and reduce a circuit load, a movement of a traditional electronic device adopts a partitioned printing method in hardware design. For example, a 384-dot zone is divided into 6 zones, and each zone is printed separately. Due to the fact that the 6 zones of the print head can be printed separately, a current demand can be reduced by a factor of 6 theoretically. However, this partition control implementation scheme cannot achieve the maximum printing efficiency in an actual working environment. For example, content to be printed is concentrated in a certain section or a few sections, and the maximum demand current of the electronic device has not been reduced, so there is an urgent need to provide a thermal printing implementation solution which is simple, power-saving and easy to use.

### SUMMARY

A purpose of the present disclosure is to overcome shortcomings of the prior art, and provide a method and an apparatus for implementing thermal printing.

In a first aspect, an embodiment of the present disclosure provides a method for implementing thermal printing, including:
step S1: obtaining power information of an electronic device upon receiving a printing instruction, obtaining a maximum available power based on the power information of the electronic device, and calculating a number of printable dots based on the maximum available power and power consumption of single-dot printing;
step S2: parsing the printing instruction to obtain data to be printed, converting the data to be printed into a two-dimensional dot-matrix pattern, and taking information of a first row in the two-dimensional dot-matrix pattern as current information to be printed;
step S3: obtaining a number of ink dots from the current information to be printed, and determining whether the number of ink dots is greater than the number of printable dots; if so, executing step S5; otherwise, executing step S4;
step S4: energizing a heating element at a corresponding position on a print head for a preset duration based on an ink-dot position in the current information to be printed, controlling a motor to feed paper, and executing step S6;
step S5: segmenting the current information to be printed based on the number of printable dots, keeping ink-dot positions in information of each segment unchanged, and filling other positions with zeroes to obtain virtual row information with the same length as the current information to be printed, energizing heating elements at corresponding positions on a print head for a preset duration based on ink-dot positions in each piece of virtual row information sequentially, controlling a motor to feed paper, and executing step S6;
step S6: determining whether the two-dimensional dot-matrix pattern has been printed completely; if so, ending; otherwise, taking information of a next row in the two-dimensional dot-matrix pattern as the current information to be printed and returning to the step S3.

In a second aspect, an embodiment of the present disclosure provides an apparatus for implementing thermal printing, including:
an obtaining and calculating module, configured to obtain a maximum available power based on power information of an electronic device upon receiving a printing instruction, and calculate a number of printable dots based on the maximum available power and power consumption of single-dot printing;
a parsing and converting module, configured to parse the printing instruction to obtain data to be printed, convert the data to be printed into a two-dimensional dot-matrix pattern, and take information of a first row in the two-dimensional dot-matrix pattern as current information to be printed;
an obtaining and determining module, configured to obtain a number of ink dots from the current information to be printed, and determine whether the number of ink dots is greater than the number of printable dots; if so, trigger a segmenting and heating module; otherwise, trigger a heating and controlling module;
the heating and controlling module, configured to energize a heating element at a corresponding position on a print head for a preset duration based on an ink-dot position in the current information to be printed, control a motor to feed paper, and trigger a determining and taking module;
the segmenting and heating module, configured to segment the current information to be printed based on the number of printable dots, keeping ink-dot positions in information of each segment unchanged, fill other positions with zeroes to obtain virtual row information with the same length as the current information to be printed, energize heating elements at corresponding positions on a print head for a preset duration based on the ink-dot positions in each piece of virtual row information sequentially, control a motor to feed paper, and trigger the determining and taking module;
the determining and taking module, configured to determine whether the two-dimensional dot-matrix pattern has been printed completely; if so, end; otherwise, take information of a next row in the two-dimensional dot-matrix pattern as the current information to be printed, and trigger the obtaining and determining module.

In a third aspect, an embodiment of the present disclosure further provides an electronic device including at least one processor, a memory, and instructions stored on the memory and executable by the at least one processor, where the at least one processor executes the instructions to implement the above method for implementing thermal printing.

In a fourth aspect, an embodiment of the present disclosure provides a computer-readable storage medium including a computer program, and when the computer program is executed on an electronic device, the electronic device is caused to perform the above method for implementing thermal printing.

In a fifth aspect, an embodiment of the present disclosure provides a chip system including a chip, where the chip is coupled to a memory, and configured to execute a computer program stored in the memory to perform the above method for implementing thermal printing.

Compared with the prior art, the present disclosure has the following advantages: in a technical solution of the present disclosure, the number of printable dots are obtained based on the available power, and information of each row of the information to be printed is segmented by the number of printable dots, virtual row information is obtained based on information of each segment and is printed in sequence; the paper is fed again when all virtual row information is printed, which can achieve precise power control and dynamically improve printing efficiency. At the same time, the maximum power available for printing can be controlled based on a power supply condition of hardware, reducing power dependence, lowering line costs and power costs. Printing operations are not limited by the power supply, allowing the electronic device to better adapt to working in a harsh power environment.

### BRIEF DESCRIPTION OF DRAWINGS

FIG. 1 is a flowchart of a method for implementing thermal printing provided by a first embodiment of the present disclosure.

FIG. 2 is a schematic diagram of a two-dimensional dot-matrix pattern, current information to be printed, and virtual row information in the first embodiment of the present disclosure.

FIGS. 3A and 3B are flowcharts of a method for implementing thermal printing provided by a second embodiment of the present disclosure.

FIG. 4 is a block diagram of an apparatus for implementing thermal printing provided by a third embodiment of the present disclosure.

### DETAILED DESCRIPTION OF EMBODIMENTS

The present disclosure proposes a method and an apparatus for implementing thermal printing. Specific embodiments of the present disclosure will be described in detail below with reference to accompanying drawings. Examples of the embodiments are shown in the accompanying drawings. The embodiments described below with reference to the accompanying drawings are exemplary and are only used to explain the present disclosure, and cannot be interpreted as limiting the present disclosure.

Those skilled in the art can understand that, unless otherwise defined, all terms used here (including technical and scientific terms) have the same meaning as those generally understood by those of ordinary skill in the art to which the present disclosure belongs. It should also be understood that terms such as those defined in general dictionaries should be understood to have meanings consistent with those in the context of the prior art, and unless specifically defined as here, they will not be interpreted with idealized or overly formal meanings.

In order to clarify purposes, technical solutions and advantages of the present disclosure, a further detailed description of implementations of the present disclosure will be provided below in conjunction with the accompanying drawings.

In an embodiment of the present disclosure, the working principle of a thermal printer is as follows: heating elements are installed at different positions on a print head of the thermal printer, and a control circuit can control the heating elements at different positions of the print head to be energized. When the certain current passes through the heating elements, a high temperature will be quickly generated. When a coating of a thermal paper encounters the energized heating elements, the temperature will rise in a very short time, and the coating on the thermal paper will undergo a chemical reaction to show color. Then, the control circuit controls a motor to rotate, enabling the print head to contact other parts of the thermal paper (i.e., controlling the motor to feed paper), thereby printing a complete pattern on the entire thermal paper.

If the thermal printer energizes one heating element, it is equivalent to heating one point (i.e., printing one ink dot); and if the thermal printer energizes multiple heating elements simultaneously, it is equivalent to heating multiple points simultaneously (i.e., printing multiple ink dots). Power and time required for heating each point are determined by power supply voltage, ambient temperature, and heating elements (such as heating resistors). Due to limited actual power supply, the number of points heated simultaneously is limited.

### First Embodiment

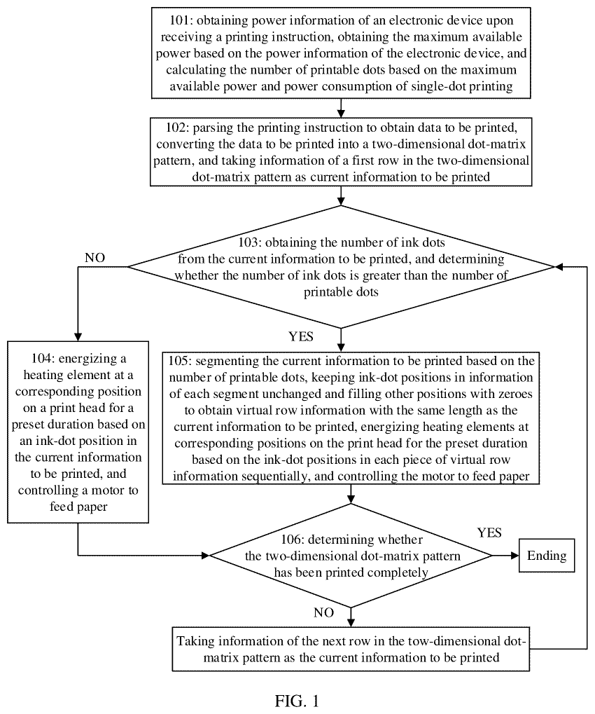

The first embodiment of the present disclosure provides a method for implementing thermal printing, as shown in FIG. 1, including the followings.

Step 101: obtaining power information of an electronic device upon receiving a printing instruction, obtaining the maximum available power based on the power information of the electronic device, and calculating the number of printable dots based on the maximum available power and power consumption of single-dot printing.

Specifically, in this embodiment, obtaining the maximum available power based on the power information of the electronic device, and calculating the number of printable dots based on the maximum available power and the power consumption of single-dot printing, includes: obtaining the maximum power of a power adapter from the power information of the electronic device, and taking a quotient of dividing the maximum power by the power consumption of single-dot printing as the number of printable dots.

Step 102: parsing the printing instruction to obtain data to be printed, converting the data to be printed into a two-dimensional dot-matrix pattern, and taking information of a first row in the two-dimensional dot-matrix pattern as current information to be printed.

Step 103: obtaining the number of ink dots from the current information to be printed, and determining whether the number of ink dots is greater than the number of printable dots; if so, executing step 105; otherwise, executing step 104.

Step 104: energizing a heating element at a corresponding position on a print head for a preset duration based on an ink-dot position in the current information to be printed, controlling a motor to feed paper, and executing step 106.

In this embodiment, before the step 104, may further include: generating a preset duration based on the number of ink dots, which specifically is: taking a result of dividing an energy consumption of single-dot printing by the power consumption of single-dot printing as the preset duration.

Step 105: segmenting the current information to be printed based on the number of printable dots, keeping ink-dot positions in information of each segment unchanged and filling other positions with zeroes to obtain virtual row information with the same length as the current information to be printed, energizing heating elements at corresponding positions on the print head for the preset duration based on the ink-dot positions in each piece of virtual row information sequentially, controlling the motor to feed paper, and executing step 106.

Specifically, in this embodiment, segmenting the current information to be printed based on the number of printable dots includes: traversing the ink dots in the current information to be printed based on the number of printable dots, and performing segmentation upon finding the same number of ink dots as the number of printable dots.

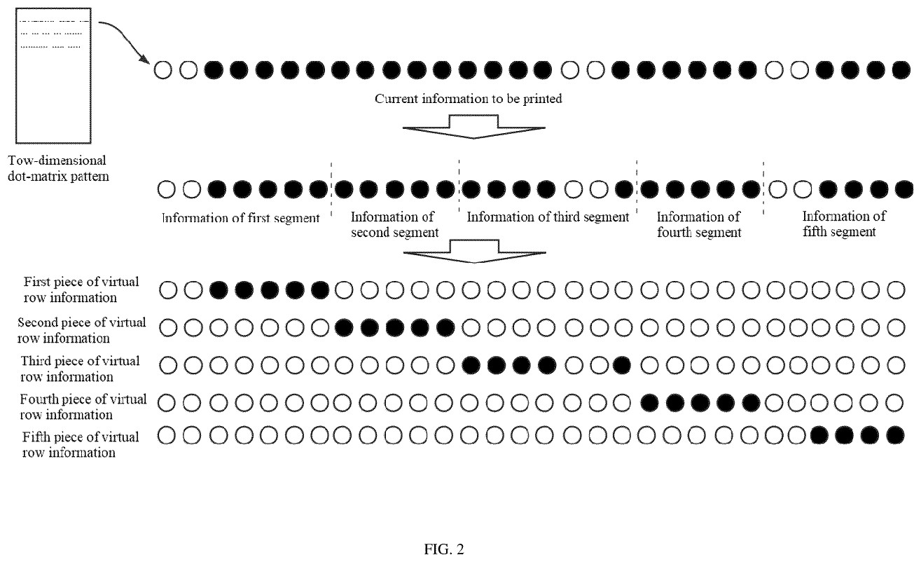

For example, in FIG. 2, information of a first row in the two-dimensional dot-matrix is taken as the current information to be printed. In this embodiment, the number of printable dots is 5, and the number of ink dots in the current information to be printed is 24. Based on the number of printable dots and the number of ink dots in the current information to be printed, the current information to be printed is divided into information of five segments, and the virtual row information obtained from information of each segment is shown in FIG. 2.

Step 106: determining whether the two-dimensional dot-matrix pattern has been printed completely; if so, ending; otherwise, taking information of the next row in the two-dimensional dot-matrix pattern as the current information to be printed, and returning to the step 103.

### Second Embodiment

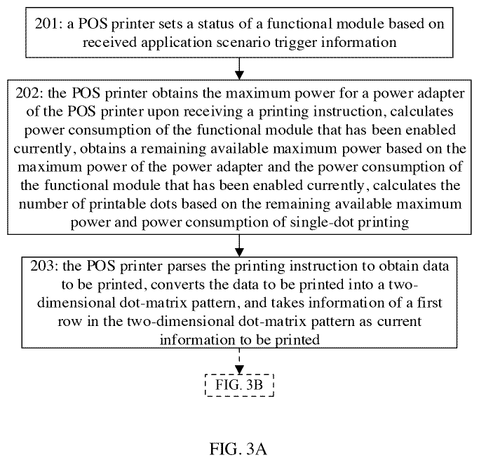

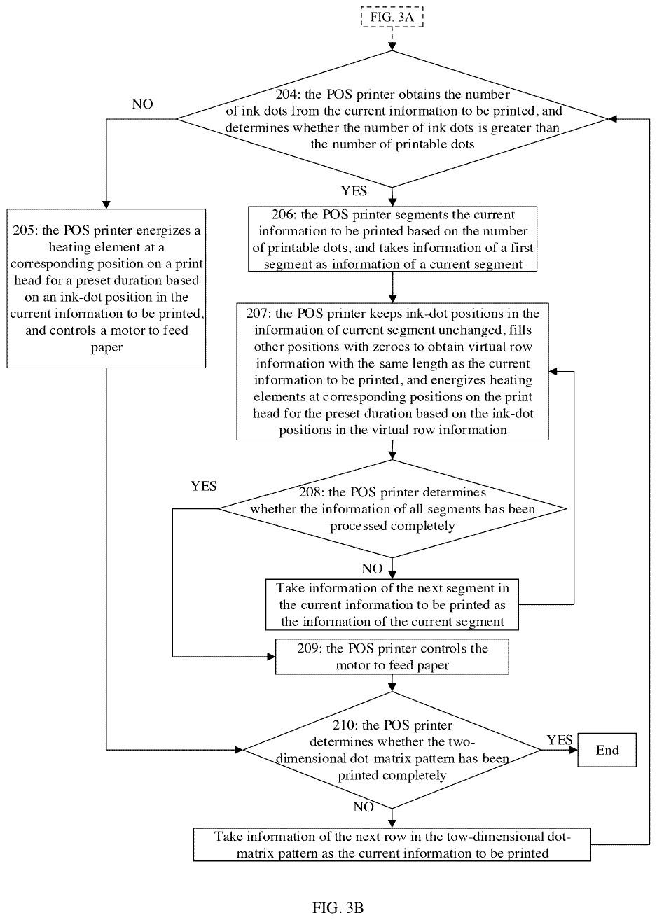

The second embodiment of the present disclosure provides a method for implementing thermal printing, applicable to a POS printer, as shown in FIGS. 3A and 3B, including the followings.

Step 201: the POS printer sets a status of a functional module based on received application scenario trigger information.

In an implementation, the functional module includes an NFC, a GPS, a speaker, a camera, etc.

In this embodiment, the step 201 specifically is: the POS printer sets the status of the functional module as enabled or disabled based on the received application scenario trigger information.

Specifically, the step 201 is: the POS printer enables the NFC, the speaker and the camera, and disables the GPS.

Step 202: the POS printer obtains the maximum power for a power adapter of the POS printer upon receiving a printing instruction, calculates power consumption of the functional module that has been enabled currently, obtains a remaining available maximum power based on the maximum power of the power adapter and the power consumption of the functional module that has been enabled currently, calculates the number of printable dots based on the remaining available maximum power and power consumption of single-dot printing.

Specifically, in this embodiment, obtaining the remaining available maximum power based on the maximum power of the power adapter and the power consumption of the functional module that has been enabled currently includes: subtracting the power consumption of the functional module that has been enabled currently from the maximum power of the power adapter to obtain the remaining available maximum power;

and specifically, calculating the number of printable dots based on the remaining available maximum power and the power consumption of single-dot printing is: dividing the remaining available maximum power by the power consumption of single-dot printing, and taking an obtained quotient as the number of printable dots.

For example, in this embodiment, the maximum power of the power adapter is Pa, the power consumption of the functional module that has been enabled currently is Pm, and then the remaining available maximum power Pr=Pa−Pm; the power consumption of single-dot printing is Db, and the number of printable dots Du=Pr/Db.

In a specific example, for a POS machine with printing function in a certain scenario, an NFC card reading module is in an operating state, and the operating current of the NFC card reading module is 120 mA; an LCD screen is in the highest backlight state, and the operating current of the LCD screen is 500 mA; a communication module is in a data transmission and reception state, and the peak current of the communication module is 1 A. A controller can calculate through detecting the operating states that, under the condition of using a power supply with 5V and 2.5 Å, the remaining maximum available power is about 4.4 W (5*(2.5−0.12−0.5−1)). The printer can calculate that the power consumption of single-dot printing is 0.24 W/dot based on the current voltage, ambient temperature, and heating resistance, and dynamically calculate to obtain that the maximum number of printable dots is 4.4 W/0.24 W/dot=18 dots.

Step 203: the POS printer parses the printing instruction to obtain data to be printed, converts the data to be printed into a two-dimensional dot-matrix pattern, and takes information of a first row in the two-dimensional dot-matrix pattern as current information to be printed.

Step 204: the POS printer obtains the number of ink dots from the current information to be printed, and determines whether the number of ink dots is greater than the number of printable dots, if so, executes step 206, otherwise, executes step 205.

Step 205: the POS printer energizes a heating element at a corresponding position on a print head for a preset duration based on an ink-dot position in the current information to be printed, controls a motor to feed paper, and executes step 210.

Step 206: the POS printer segments the current information to be printed based on the number of printable dots, and takes information of a first segment as information of a current segment.

Specifically, in this embodiment, the segmenting the current information to be printed based on the number of printable dots includes: traversing ink dots in the current information to be printed based on the number of printable dots, and performing segmentation upon finding the same number of ink dots as the number of printable dots.

For example, the number of printable dots is 18, the ink dots in the current information to be printed are traversed, and the segmentation is performed when finding the 18th ink dot, and the remaining ink dots in the current information to be printed are traversed again, and the segmentation is performed when finding the 18th dot, until all ink dots in the current information to be printed are traversed.

Step 207: the POS printer keeps ink-dot positions in the information of current segment unchanged, fills other positions with zeroes to obtain virtual row information with the same length as the current information to be printed, and energizes heating elements at corresponding positions on the print head for the preset duration based on the ink-dot positions in the virtual row information.

Step 208: the POS printer determines whether the information of all segment has been processed completely, if so, executes step 209, otherwise, takes information of the next segment in the current information to be printed as the information of the current segment and returns to the step 207.

Step 209: the POS printer controls the motor to feed paper, and executes step 210.

Step 210: the POS printer determines whether the two-dimensional dot-matrix pattern has been printed completely, if so, ending; otherwise, takes information of the next row in the two-dimensional dot-matrix pattern as the current information to be printed and returns to the step 204.

In this embodiment, the number of printable dots is dynamically calculated, achieving variable-speed printing and maximizing power utilization, making the POS printer adaptable to more complex power environments.

In the embodiment of the present disclosure, information of each row in the information to be printed is divided based on a power supply situation, and information of each divided segment is modified to the virtual row information. For example, if it is calculated that the power supply only supports at most 18-point printing (which is the number of printable dots), information of the current row is modified to several pieces of virtual row information with 18 ink dots. Different pieces of virtual row information are printed sequentially until all virtual row information is printed, that is, until printing of the information of current row is completed. Then, the motor is controlled to feed paper and information of the next row is continued to be segmented and printed until all the information to be printed is completely printed. The printing process is simple and convenient, and power utilization can be dynamically improved; and a problem of equipment malfunction due to excessive current when printing large patterns and QR codes can be solved.

### Third Embodiment

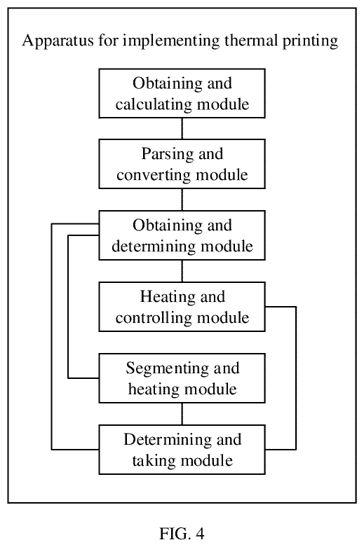

The third embodiment of the present disclosure provides an apparatus for implementing thermal printing, as shown in FIG. 4, including the followings.

An obtaining and calculating module is configured to obtain the maximum available power based on power information of an electronic device upon receiving a printing instruction, and calculate the number of printable dots based on the maximum available power and power consumption of single-dot printing.

In an implementation, the obtaining and calculating module in this embodiment is specifically configured to obtain the maximum power of a power adapter from the power information of the electronic device upon receiving the printing instruction, and take a quotient of dividing the maximum power by the power consumption of single-dot printing as the number of printable dots.

A parsing and converting module is configured to parse the printing instruction to obtain data to be printed, convert the data to be printed into a two-dimensional dot-matrix pattern, and take information of a first row in the two-dimensional dot-matrix pattern as current information to be printed.

An obtaining and determining module is configured to obtain the number of ink dots from the current information to be printed, determine whether the number of ink dots is greater than the number of printable dots; if so, trigger a segmenting and heating module; otherwise, trigger a heating and controlling module.

The heating and controlling module is configured to energize a heating element at a corresponding position on a print head for a preset duration based on an ink-dot position in the current information to be printed, control a motor to feed paper, and trigger a determining and taking module.

The segmenting and heating module is configured to segment the current information to be printed based on the number of printable dots, keep ink-dot positions in information of each segment unchanged and fill zeroes in other positions to obtain virtual row information with the same length as the current information to be printed, energize heating elements at corresponding positions on the print head for the preset duration based on the ink-dot positions in each piece of virtual row information sequentially, control the motor to feed paper, and trigger the determining and taking module.

The determining and taking module is configured to determine whether the two-dimensional dot-matrix pattern has been printed completely; if so, end a printing process; otherwise, take information of the next row in the two-dimensional dot-matrix pattern as the current information to be printed, and trigger the obtaining and determining module.

In an implementation, the apparatus of this embodiment also includes:
a setting module, configured to set a status of a functional module as enabled or disabled based on received application scenario trigger information;
correspondingly, the obtaining and calculating module is specifically configured to obtain the maximum power for the power adapter of the electronic device upon receiving the printing instruction, calculate the power consumption of the functional module that has been enabled currently, obtain the remaining available maximum power based on the maximum power for the power adapter of the electronic device and the power consumption of the functional module that has been enabled currently, and calculate the number of printable dots based on the remaining available maximum power.

Furthermore, the obtaining and calculating module is specifically configured to obtain the maximum power for the power adapter of the electronic device upon receiving the printing instruction, calculate the power consumption of the functional module that has been enabled currently, subtract the power consumption of the functional module that has been enabled currently from the maximum power for the power adapter of the electronic device to obtain the remaining available maximum power, and take the quotient of dividing the remaining available maximum power by the power consumption of single-dot printing as the number of printable dots.

Furthermore, the segmenting and heating module in this embodiment includes:
a segmenting and taking unit, configured to segment the current information to be printed based on the number of printable dots, and take the information of a first segment as the information of a current segment;
a filling and heating unit, configured to keep ink-dot positions in the information of the current segment unchanged, and fill other positions with zeroes to obtain virtual row information with the same length as the current information to be printed, and energize the heating elements at the corresponding positions on the print head for the preset duration based on the ink-dot positions in the virtual row information;
a determining and taking unit, configured to determine whether information of all segments has been processed completely; if so, trigger a controlling unit; otherwise, take information of the next segment in the current information to be printed as the information of the current segment, and trigger the filling and heating unit;
the controlling unit, configured to control the motor to feed paper and trigger the determining and taking module.

In this embodiment, the segmenting and heating module is configured to segment the current information to be printed based on the number of printable dots; specifically, the segmenting and heating module is configured to traverse the ink dots in the current information to be printed based on the number of printable dots, and perform segmentation upon finding an ink-dot has a traversal serial number being same with the number of printable dots.

In an implementation, an embodiment of the present disclosure also provides an electronic device including at least one processor, a memory, and instructions stored on the memory and executable by the at least one processor. The at least one processor executes the instructions to implement the methods for implementing thermal printing in the above embodiments. When the electronic device is a chip system, it can be composed of a chip or include a chip and other discrete components, and embodiments of the present disclosure do not specifically limit this. The chip is coupled with a memory and configured to execute a computer program stored in the memory, to implement the method for thermal printing as disclosed in the above embodiments.

The above embodiments can be fully or partially implemented through software, hardware, firmware, or any combination thereof. When implemented using a software programs, they can be fully or partially implemented in the form of a computer program product. The computer program product includes one or more computer programs. When loading and executing the computer programs on an electronic device, all or part of processes or functions described in the embodiments of the present disclosure are generated. The computer program can be stored in a computer-readable storage medium or transmitted from one computer-readable storage medium to another. For example, the computer instructions can be transmitted from a base station, an electronic device, a server, or a data center to another base station, electronic device, server, or data center via wired (such as a coaxial cable, a fiber optic, a digital subscriber line (DSL)) or wireless (such as infrared, wireless, microwave, and the like) means. The computer-readable storage medium can be any available medium that the electronic devices can access, or it can include one or more data storage devices such as servers, data centers and the like that can be integrated with the medium. The available media can be magnetic media (such as floppy disks, hard drives, magnetic tapes), optical media (such as DVDs), or media (such as solid state drives (SSD)), and the like. In an embodiment of the present disclosure, the electronic device may include the apparatus mentioned above.

Although the present disclosure has been described in conjunction with various embodiments, those skilled in the art can understand and implement other variations of embodiments of the present disclosure by examining the accompanying drawings, disclosed content, and claims. In the claims, a word “comprising” does not exclude other components or steps, and “a” or “an” does not exclude a situation of multiple. A single processor or other unit can implement several functions listed in the claims. Different dependent claims recite certain measures, but this does not mean that these measures cannot be combined to produce good results.

Although the present disclosure has been described in conjunction with specific features and embodiments, it is evident that various modifications and combinations can be made without departing from spirit and scope of the present disclosure. Correspondingly, this specification and the accompanying drawings are merely illustrative of the disclosure as defined by the claims, and are deemed to cover any and all modifications, variations, combinations, or equivalents within the scope of the present disclosure. Obviously, those skilled in the art can make various modifications and variations to the present disclosure without departing from the spirit and scope of the present disclosure. In this way, if these modifications and variations disclosed herein fall within the scope of the claims and their equivalent technologies, then the present disclosure is also intended to include these modifications and variations.

1-10. (canceled)

11. A method for implementing thermal printing, comprising:
step S1: obtaining power information of an electronic device upon receiving a printing instruction, obtaining a maximum available power based on the power information of the electronic device, and calculating a number of printable dots based on the maximum available power and power consumption of single-dot printing;
step S2: parsing the printing instruction to obtain data to be printed, converting the data to be printed into a two-dimensional dot-matrix pattern, and taking information of a first row in the two-dimensional dot-matrix pattern as current information to be printed;
step S3: obtaining a number of ink dots from the current information to be printed, and determining whether the number of ink dots is greater than the number of printable dots; if so, executing step S5; otherwise, executing step S4;
step S4: energizing a heating element at a corresponding position on a print head for a preset duration based on an ink-dot position in the current information to be printed, and controlling a motor to feed paper, and executing step S6;
step S5: segmenting the current information to be printed based on the number of printable dots, keeping ink-dot positions in information of each segment unchanged, and filling other positions with zeroes to obtain virtual row information with a same length as the current information to be printed; energizing heating elements at corresponding positions on the print head for the preset duration based on the ink-dot positions in each piece of virtual row information sequentially, controlling the motor to feed paper, and executing step S6; and
step S6: determining whether the two-dimensional dot-matrix pattern has been printed completely; if so, ending; otherwise, taking information of a next row in the two-dimensional dot-matrix pattern as the current information to be printed and returning to the step S3.

12. The method according to claim 11, wherein obtaining the maximum available power based on the power information of the electronic device, and calculating the number of printable dots based on the maximum available power and the power consumption of single-dot printing, comprises: obtaining the maximum power of a power adapter from the power information, and taking a quotient of dividing the maximum power by the power consumption of single-dot printing as the number of printable dots

13. The method according to claim 11, before the step S1, further comprising: setting a status of a functional module as enabled or disabled based on received application scenario trigger information;
and step S1 further comprises: obtaining the maximum power for the power adapter of the electronic device upon receiving the printing instruction, calculating power consumption of a functional module that has been enabled currently, obtaining a remaining available maximum power based on the maximum power for the power adapter of the electronic device and the power consumption of the functional module that has been enabled currently, and calculating the number of printable dots based on the remaining available maximum power.

14. The method according to claim 13, wherein obtaining the remaining available maximum power based on the maximum power for the power adapter of the electronic device and the power consumption of the functional module that has been enabled currently comprises: subtracting the power consumption of the functional module that has been enabled currently from the maximum power for the power adapter of the electronic device to obtain the remaining available maximum power;
and calculating the number of printable dots based on the remaining available maximum power, is: taking a quotient of dividing the remaining available maximum power by the power consumption of single-dot printing as the number of printable dots.

15. The method according to claim 11, wherein step S5 comprises:
step S51: segmenting the current information to be printed based on the number of printable dots, and taking information of a first segment as information of a current segment;
step S52: keeping the ink-dot positions in the information of the current segment unchanged, filling other positions with zeroes to obtain the virtual row information with the same length as the current information to be printed, energizing the heating elements at the corresponding positions on the print head for the preset duration based on the ink-dot positions in the virtual row information;
step S53: determine whether information of all segments has been processed completely; if so, executing step S54; otherwise, taking information of a next segment in the current information to be printed as the information of the current segment and returning to step S52; and
step S54: controlling the motor to feed paper and executing step S6.

16. The method according to claim 11, wherein the segmenting the current information to be printed based on the number of printable dots comprises: traversing ink dots in the current information to be printed based on the number of printable dots, and performing segmentation upon finding a same number of ink dots as the number of printable dots.

17. An apparatus for implementing thermal printing, comprising:
at least one processor, a memory, and instructions stored on the memory and executable by the at least one processor, the at least one processor executing the instructions to implement the following steps:
step S1: obtaining power information of an electronic device upon receiving a printing instruction, obtaining a maximum available power based on the power information of the electronic device, and calculating a number of printable dots based on the maximum available power and power consumption of single-dot printing;
step S2: parsing the printing instruction to obtain data to be printed, converting the data to be printed into a two-dimensional dot-matrix pattern, and taking information of a first row in the two-dimensional dot-matrix pattern as current information to be printed;
step S3: obtaining a number of ink dots from the current information to be printed, and determining whether the number of ink dots is greater than the number of printable dots; if so, executing step S5; otherwise, executing step S4;
step S4: energizing a heating element at a corresponding position on a print head for a preset duration based on an ink-dot position in the current information to be printed, and controlling a motor to feed paper, and executing step S6;
step S5: segmenting the current information to be printed based on the number of printable dots, keeping ink-dot positions in information of each segment unchanged, and filling other positions with zeroes to obtain virtual row information with a same length as the current information to be printed; energizing heating elements at corresponding positions on the print head for the preset duration based on the ink-dot positions in each piece of virtual row information sequentially, controlling the motor to feed paper, and executing step S6; and
step S6: determining whether the two-dimensional dot-matrix pattern has been printed completely; if so, ending; otherwise, taking information of a next row in the two-dimensional dot-matrix pattern as the current information to be printed and returning to the step S3.

18. A non-transitory computer-readable storage medium comprising a computer program, wherein when the computer program is running on an electronic device, the electronic device is caused to perform the following steps:
step S1: obtaining power information of an electronic device upon receiving a printing instruction, obtaining a maximum available power based on the power information of the electronic device, and calculating a number of printable dots based on the maximum available power and power consumption of single-dot printing;
step S2: parsing the printing instruction to obtain data to be printed, converting the data to be printed into a two-dimensional dot-matrix pattern, and taking information of a first row in the two-dimensional dot-matrix pattern as current information to be printed;
step S3: obtaining a number of ink dots from the current information to be printed, and determining whether the number of ink dots is greater than the number of printable dots; if so, executing step S5; otherwise, executing step S4;
step S4: energizing a heating element at a corresponding position on a print head for a preset duration based on an ink-dot position in the current information to be printed, and controlling a motor to feed paper, and executing step S6;
step S5: segmenting the current information to be printed based on the number of printable dots, keeping ink-dot positions in information of each segment unchanged, and filling other positions with zeroes to obtain virtual row information with a same length as the current information to be printed; energizing heating elements at corresponding positions on the print head for the preset duration based on the ink-dot positions in each piece of virtual row information sequentially, controlling the motor to feed paper, and executing step S6; and
step S6: determining whether the two-dimensional dot-matrix pattern has been printed completely; if so, ending; otherwise, taking information of a next row in the two-dimensional dot-matrix pattern as the current information to be printed and returning to the step S3.

19. The apparatus according to claim 17, wherein the at least one processor further executes the instructions to: obtain the maximum power of a power adapter from the power information, and take a quotient of dividing the maximum power by the power consumption of single-dot printing as the number of printable dots.

20. The apparatus according to claim 17, wherein, before step S1, the at least one processor further executes the instructions to: set a status of a functional module as enabled or disabled based on received application scenario trigger information;
and step S1 comprises: obtaining the maximum power for the power adapter of the electronic device upon receiving the printing instruction, calculating power consumption of a functional module that has been enabled currently, obtaining a remaining available maximum power based on the maximum power for the power adapter of the electronic device and the power consumption of the functional module that has been enabled currently, and calculating the number of printable dots based on the remaining available maximum power.

21. The apparatus according to claim 20, wherein obtaining the remaining available maximum power based on the maximum power for the power adapter of the electronic device and the power consumption of the functional module that has been enabled currently comprises: subtracting the power consumption of the functional module that has been enabled currently from the maximum power for the power adapter of the electronic device to obtain the remaining available maximum power;
and calculating the number of printable dots based on the remaining available maximum power, specifically is: taking a quotient of dividing the remaining available maximum power by the power consumption of single-dot printing as the number of printable dots.

22. The apparatus according to claim 17, wherein step S5 comprises:
step S51: segmenting the current information to be printed based on the number of printable dots, and taking information of a first segment as information of a current segment;
step S52: keeping the ink-dot positions in the information of the current segment unchanged, filling other positions with zeroes to obtain the virtual row information with the same length as the current information to be printed, energizing the heating elements at the corresponding positions on the print head for the preset duration based on the ink-dot positions in the virtual row information;
step S53: determine whether information of all segments has been processed completely; if so, executing step S54; otherwise, taking information of a next segment in the current information to be printed as the information of the current segment and returning to step S52; and
step S54: controlling the motor to feed paper and executing step S6.

23. The apparatus according to claim 17, wherein the at least one processor further executes the instructions to: travers ink dots in the current information to be printed based on the number of printable dots, and perform segmentation upon finding a same number of ink dots as the number of printable dots.

24. The non-transitory computer-readable storage medium according to claim 18, wherein the electronic device is further caused to: obtain the maximum power of a power adapter from the power information, and take a quotient of dividing the maximum power by the power consumption of single-dot printing as the number of printable dots.

25. The non-transitory computer-readable storage medium according to claim 18, wherein, before step S1, the electronic device is further caused to: set a status of a functional module as enabled or disabled based on received application scenario trigger information;
and step S1 further comprises: obtaining the maximum power for the power adapter of the electronic device upon receiving the printing instruction, calculating power consumption of a functional module that has been enabled currently, obtaining a remaining available maximum power based on the maximum power for the power adapter of the electronic device and the power consumption of the functional module that has been enabled currently, and calculating the number of printable dots based on the remaining available maximum power.

26. The non-transitory computer-readable storage medium according to claim 25, wherein obtaining the remaining available maximum power based on the maximum power for the power adapter of the electronic device and the power consumption of the functional module that has been enabled currently comprises: subtracting the power consumption of the functional module that has been enabled currently from the maximum power for the power adapter of the electronic device to obtain the remaining available maximum power;
and calculating the number of printable dots based on the remaining available maximum power, specifically is: taking a quotient of dividing the remaining available maximum power by the power consumption of single-dot printing as the number of printable dots.

27. The non-transitory computer-readable storage medium according to claim 18, wherein the step S5 further comprises:
step S51: segmenting the current information to be printed based on the number of printable dots, and taking information of a first segment as information of a current segment;
step S52: keeping the ink-dot positions in the information of the current segment unchanged, filling other positions with zeroes to obtain the virtual row information with the same length as the current information to be printed, energizing the heating elements at the corresponding positions on the print head for the preset duration based on the ink-dot positions in the virtual row information;
step S53: determine whether information of all segments has been processed completely; if so, executing step S54; otherwise, taking information of a next segment in the current information to be printed as the information of the current segment and returning to step S52; and
step S54: controlling the motor to feed paper and executing step S6.

28. The non-transitory computer-readable storage medium according to claim 18, wherein the electronic device is further caused to: travers ink dots in the current information to be printed based on the number of printable dots, and perform segmentation upon finding a same number of ink dots as the number of printable dots.
